(19) United States
(12) Patent Application Publication
(10) Pub. No.: US 2026/0321464 A1
(43) Pub. Date: Oct. 15, 2026

(54) GROMMET AND WIRE HARNESS

(71) Applicant: SUMITOMO WIRING SYSTEMS, LTD., Yokkaichi-shi (JP)

(72) Inventor: Yuichi MURAKAMI, Yokkaichi-shi (JP)

(73) Assignee: SUMITOMO WIRING SYSTEMS, LTD., Yokkaichi-shi (JP)

(21) Appl. No.: 19/642,112

(22) Filed: Apr. 8, 2026

(30) Foreign Application Priority Data
Apr. 9, 2025 (JP) 2025-064263

(51) Int. Cl. H01B 17/58

(52) U.S. Cl. CPC H01B 17/583

(57) ABSTRACT

A grommet including: a tubular body that includes: a first fixed portion that is configured to be fixed to a tubular shield shell that covers an outer periphery of a connector housing; a second fixed portion that is configured to be fixed to a tubular exterior member that covers an outer periphery of an electric wire extending from the connector housing; and a tubular folding portion that is provided between the first fixed portion and the second fixed portion and has a diameter that decreases toward the second fixed portion.

### BACKGROUND

The present disclosure relates to a grommet and a wire harness.

Conventionally, some vehicle wire harnesses include a tubular shield shell that covers the outer periphery of a connector housing and a tubular grommet that covers the shield shell (refer to JP 2018-121467A, for example). The grommet includes a first fixed portion fixed to the shield shell and a second fixed portion fixed to a tubular exterior member that covers the outer periphery of an electric wire extending from the connector housing. The shield shell, the connector housing, and the grommet are each provided at both ends of the wire harness in the longitudinal direction.

### SUMMARY

At least at one longitudinal end of the wire harness, the grommet needs to be fixed to the exterior member before attaching the terminal and the electric wire to the connector housing. This causes a problem that the grommet may interfere with the work of attaching the terminal and the electric wire to the connector housing at the end of the wire harness, thereby making the work difficult.

An exemplary aspect of the disclosure provides a grommet and a wire harness that make it possible to easily secure a working space.

A grommet of the present disclosure includes: a first fixed portion configured to be fixed to a tubular shield shell that covers an outer periphery of a connector housing; a second fixed portion configured to be fixed to a tubular exterior member that covers an outer periphery of an electric wire extending from the connector housing; and a tubular folding portion that is provided between the first fixed portion and the second fixed portion and has a diameter that decreases toward the second fixed portion, wherein the folding portion includes a plurality of annular mountain fold portions, a plurality of annular valley fold portions, and a plurality of coupling wall portions that couple the mountain fold portions and the valley fold portions, the plurality of mountain fold portions and the plurality of valley fold portions are alternately provided from a first fixed portion side toward a second fixed portion side, the plurality of coupling wall portions are respectively provided between the plurality of mountain fold portions and the plurality of valley fold portions, and the folding portion is configured to be held in a folded state in which the plurality of coupling wall portions are aligned in a radial direction, by the plurality of mountain fold portions and the plurality of valley fold portions being folded.

According to the grommet and wire harness of the present disclosure, it is possible to easily secure a working space.

### BRIEF DESCRIPTION OF THE DRAWINGS

FIG. 1 is a side view of a portion of a wire harness according to an embodiment.

FIG. 2 is a schematic cross-sectional view of the portion of the wire harness according to the embodiment.

FIG. 3 is a schematic cross-sectional view of the wire harness in a state of being assembled in the embodiment.

### EMBODIMENTS OF THE DISCLOSURE

### Description of Embodiments of Present Disclosure

First, embodiments of the present disclosure will be listed and described.

[1] A grommet according to an aspect of the present disclosure includes: a first fixed portion configured to be fixed to a tubular shield shell that covers an outer periphery of a connector housing; a second fixed portion configured to be fixed to a tubular exterior member that covers an outer periphery of an electric wire extending from the connector housing; and a tubular folding portion that is provided between the first fixed portion and the second fixed portion and has a diameter that decreases toward the second fixed portion, wherein the folding portion includes a plurality of annular mountain fold portions, a plurality of annular valley fold portions, and a plurality of coupling wall portions that couple the mountain fold portions and the valley fold portions, the plurality of mountain fold portions and the plurality of valley fold portions are alternately provided from a first fixed portion side toward a second fixed portion side, the plurality of coupling wall portions are respectively provided between the plurality of mountain fold portions and the plurality of valley fold portions, and the folding portion is configured to be held in a folded state in which the plurality of coupling wall portions are aligned in a radial direction, by the plurality of mountain fold portions and the plurality of valley fold portions being folded.

With this configuration, folding the folding portion into the folded state makes it possible to sufficiently expose a portion of the electric wire in the longitudinal direction to the outside of the grommet. Accordingly, it is possible to easily secure a working space.

[2] In aspect [1] above, the first fixed portion may be fastened and fixed to the shield shell by a first fixing band from an outer peripheral side, and a first arrangement groove in which the first fixing band is arrangeable may be provided the first fixed portion on an outer peripheral surface of the first fixed portion.

With this configuration, movement of the first fixing band can be restricted by the first arrangement groove. Accordingly, displacement of the first fixing band can be suppressed by the first arrangement groove.

[3] In aspect [1] or [2] above, the second fixed portion may be fastened and fixed to the exterior member by a second fixing band from an outer peripheral side, and a second arrangement groove in which the second fixing band is arrangeable may be provided on an outer peripheral surface the second fixed portion.

With this configuration, movement of the second fixing band can be restricted by the second arrangement groove. Accordingly, displacement of the second fixing band can be suppressed by the second arrangement groove.

[4] A wire harness of the present disclosure includes the grommet according to any one of aspects [1] to [3] above.

With this configuration, folding the folding portion into the folded state makes it possible to sufficiently expose a portion of the electric wire in the longitudinal direction to the outside of the grommet. Accordingly, it is possible to easily secure a working space.

### Details of Embodiments of Present Disclosure

Specific examples of the present disclosure will be described below with reference to the drawings. In the drawings, some components may be exaggerated or simplified for ease of description. The dimensional ratio of each component may differ among the drawings. The term "tubular" in this specification is used not only for an object with a continuous peripheral wall formed around the entire circumference, but also for an object formed by combining a plurality of components and an object with a cutout in a portion in the circumferential direction, such as a C-shaped object. The outer peripheral shape of a "tubular" object includes, but is not limited to, a circle, an ellipse, and a polygon with sharp or rounded corners. The "tubular" object has a shape with a through hole in a planar view, including a shape in which the outer peripheral shape and the inner peripheral shape of the through hole are the same, and the shape in which the outer peripheral shape and the inner peripheral shape of the through hole are different. The "tubular" object includes an object having a predetermined length and extending along the axial direction of the center axis passing through the center of the through hole, regardless of whether the length is long or short. Furthermore, the terms "first", "second", and the like in this specification are used merely to distinguish between objects and do not rank them. It should be noted that the present disclosure is not limited to the examples herein, but rather is indicated by the scope of claims, and is intended to include all modifications within a meaning and scope equivalent to the scope of claims.

### Overall Configuration of Wire Harness 10

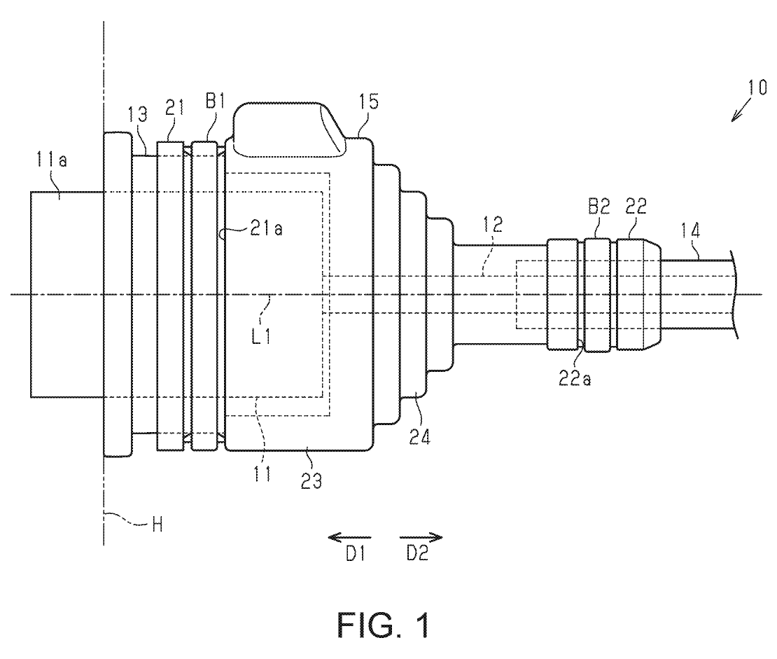

A wire harness 10 illustrated in FIG. 1 is mounted in a vehicle such as a hybrid vehicle or an electric vehicle, for example. The wire harness 10 electrically connects in-vehicle devices to each other. Examples of in-vehicle devices electrically connected by the wire harness 10 include a high-voltage battery, an inverter, and a motor.

As illustrated in FIG. 1, the wire harness 10 includes a connector housing 11, an electric wire 12, a shield shell 13, an exterior member 14, and a grommet 15. The connector housing 11, the shield shell 13, and the grommet 15 are provided at an end of the wire harness 10 in the longitudinal direction.

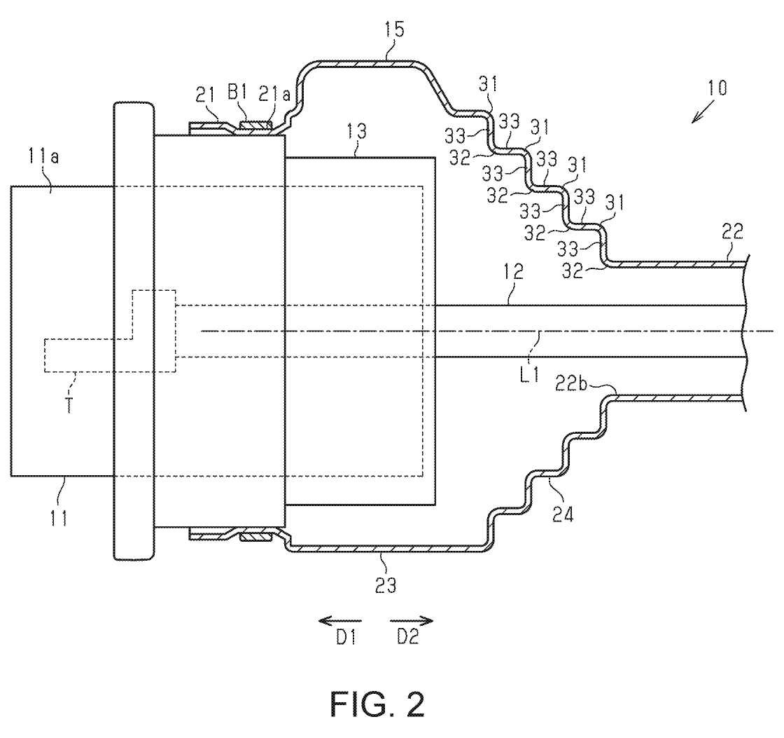

As illustrated in FIG. 2, the connector housing 11 houses a terminal T connected to an end of the electric wire 12. The electric wire 12 connected to the terminal T in the connector housing 11 is drawn out from the connector housing 11. The exterior member 14 covers the outer periphery of the portion of the electric wire 12 that extends from the connector housing 11. The exterior member 14 is a corrugated tube having a bellows structure formed of an insulating material such as synthetic resin, for example.

### Configuration of Shield Shell 13

The shield shell 13 has a tubular shape to cover the outer periphery of the connector housing 11. The shield shell 13 is formed of a conductive material such as metal. The shield shell 13 is fastened and fixed to a housing H of the in-vehicle device by bolts (not illustrated), for example.

A portion of the connector housing 11 on the base end side is housed in the shield shell 13, and has a mating portion 11a on the leading end side protruding outward from the shield shell 13. The mating portion 11a is connected to a mating connector (not illustrated) provided in the housing H of the in-vehicle device. When the mating portion 11a is connected to the mating connector, the terminal T in the connector housing 11 is electrically connected to a mating terminal of the mating connector. The connector housing 11 and the shield shell 13 are attaching to the housing H in a first direction D1 along the longitudinal direction of the wire harness 10. In the following description, the direction opposite to the first direction D1 will be referred to as a second direction D2.

### Configuration of Grommet 15

As illustrated in FIGS. 1 and 2, the grommet 15 is formed in a tubular shape from a flexible material such as rubber or elastomer. The grommet 15 includes a first fixed portion 21 fixed to the shield shell 13 and a second fixed portion 22 fixed to the exterior member 14. The first fixed portion 21 is provided at one end of the grommet 15 in the first direction D1. The second fixed portion 22 is provided at one end of the grommet 15 in the second direction D2. The grommet 15 has a tubular shape throughout the direction of an axis L1 from the first fixed portion 21 to the second fixed portion 22. The first direction D1 and second direction D2 are directions along the axis L1 of the grommet 15.

As illustrated in FIG. 1, a portion of the shield shell 13 is inserted into the first fixed portion 21 of the grommet 15. The first fixed portion 21 is fixed in a liquid-tight manner to the outer peripheral surface of the shield shell 13 by a first fixing band B1 constituted by a cable tie or the like, for example. The first fixing band B1 is arranged in a first arrangement groove 21a provided on the outer peripheral surface of the first fixed portion 21. The first arrangement groove 21a restricts movement of the first fixing band B1 in the direction of the axis L1.

One end of the exterior member 14 is inserted into the second fixed portion 22 of the grommet 15. The second fixed portion 22 is fixed in a liquid-tight manner to the outer peripheral surface of the shield shell 13 by a second fixing band B2 constituted by a cable tie, for example. The second fixing band B2 is arranged in a second arrangement groove 22a provided on the outer peripheral surface of the second fixed portion 22. The second arrangement groove 22a restricts movement of the second fixing band B2 in the direction of the axis L1. Note that the inner peripheral surface of the second fixed portion 22 may be provided with a lip (not illustrated) that fits into a recess on the outer periphery of the exterior member 14 (corrugated tube).

The grommet 15 includes a housing portion 23 and a folding portion 24 that are provided between the first fixed portion 21 and the second fixed portion 22. The housing portion 23 is provided between the first fixed portion 21 and the folding portion 24 in the direction of the axis L1. The folding portion 24 is provided between the housing portion 23 and the second fixed portion 22 in the direction of the axis L1. A portion of the shield shell 13 is housed in the housing portion 23. In the housing portion 23, a braided wire (not illustrated) that covers the outer periphery of the electric wire 12 is fixed to the outer peripheral surface of the shield shell 13 by a crimping ring or the like.

### Configuration of Folding Portion 24

As illustrated in FIG. 2, the folding portion 24 of the grommet 15 is formed such that the outer diameter of the folding portion 24 decreases from the housing portion 23 to the second fixed portion 22. That is, the folding portion 24 has a tubular shape whose diameter decreases toward the second fixed portion 22.

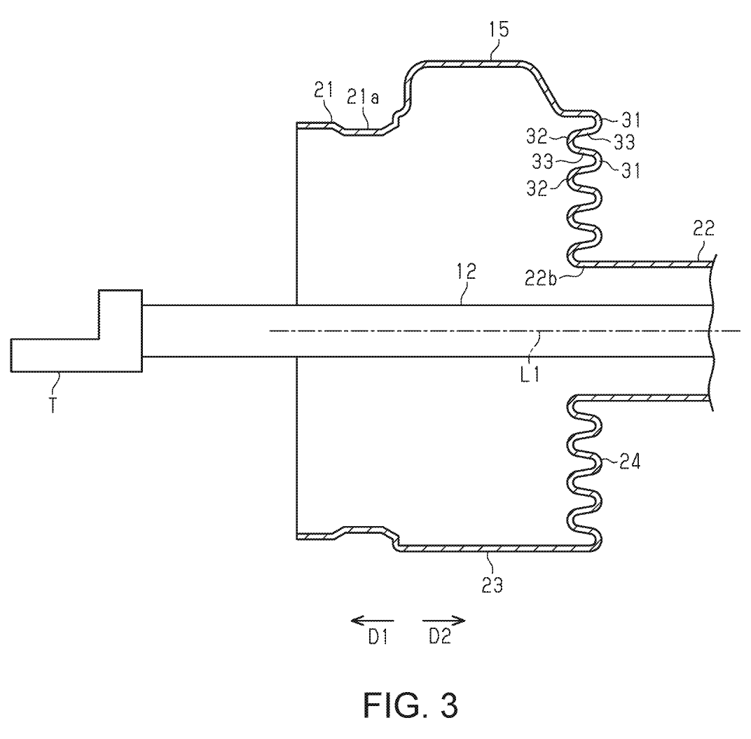

The folding portion 24 can be transitioned between an unfolded state illustrated in FIG. 2 and a folded state illustrated in FIG. 3. Specifically, as illustrated in FIG. 2, the folding portion 24 includes a plurality of annular mountain fold portions 31, a plurality of annular valley fold portions 32, and a plurality of coupling wall portions 33 that couple the mountain fold portions 31 and the valley fold portions 32. The plurality of mountain fold portions 31 and the plurality of valley fold portions 32 are alternately provided from the first fixed portion 21 side toward the second fixed portion 22 side in the direction of the axis L1. The plurality of coupling wall portions 33 are provided between the plurality of mountain fold portions 31 and the plurality of valley fold portions 32. The mountain fold portions 31 and the valley fold portions 32 are bent at approximately right angles, for example. As illustrated in FIG. 3, by folding the mountain fold portions 31 and the valley fold portions 32, the folding portion 24 is held in a folded state in which the plurality of coupling wall portions 33 are aligned in the radial direction centered on the axis L1. The mountain fold portions 31, the valley fold portions 32, and the coupling wall portions 33 of the folding portion 24 in the folded state are each arranged along the radial direction on the outer periphery of an end 22b of the second fixed portion 22 in the first direction D1, for example.

### Operation of Present Embodiment

Operation of the present embodiment will be described below.

When assembling the wire harness 10, before attaching the terminal T and the electric wire 12 to the connector housing 11, the terminal T and the electric wire 12 are passed through the second fixed portion 22 into the grommet 15. Next, the end of the exterior member 14 is inserted into the second fixed portion 22 of the grommet 15, and then the second fixed portion 22 is fastened and fixed to the exterior member 14 by the second fixing band B2. Here, if the connector housing 11 has been attached first to the end of the wire harness 10 opposite to the end where the connector housing 11 is to be attached, movement of the electric wire 12 that is to be drawn out from the exterior member 14 in the first direction D1 is restricted.

Therefore, when attaching the terminal T and the electric wire 12 to the connector housing 11 with the second fixed portion 22 of the grommet 15 fixed to the exterior member 14 as described above, the folding portion 24 is placed in the folded state in which the mountain fold portions 31 and the valley fold portions 32 are folded. At this time, the folding portion 24 is held in the folded state by folding the mountain fold portions 31 and the valley fold portions 32. By placing the folding portion 24 in the folded state in this manner, the first fixed portion 21 (the end of the grommet 15 in the first direction D1) can be retracted in the second direction D2, so that longitudinal portions of the terminal T and the electric wire 12 can be sufficiently exposed to the outside of the grommet 15. This makes it possible to easily secure a space for attaching the terminal T to the connector housing 11 and subsequently attaching the connector housing 11 to the shield shell 13, for example.

### Advantageous Effects of Present Embodiment

Advantageous effects of the present embodiment will be described below.
(1) The folding portion 24 of the grommet 15 is configured so as to be held in the folded state in which the plurality of coupling wall portions 33 are aligned in the radial direction by the plurality of mountain fold portions 31 and the plurality of valley fold portions 32 being folded. With this configuration, folding the folding portion 24 into the folded state makes it possible to easily secure a working space.
(2) The first fixed portion 21 is fastened and fixed to the shield shell 13 by the first fixing band B1 from the outer peripheral side, and the first arrangement groove 21a in which the first fixing band B1 is arranged is provided on the outer peripheral surface of the first fixed portion 21. With this configuration, movement of the first fixing band B1 can be restricted by the first arrangement groove 21a. Accordingly, displacement of the first fixing band B1 can be suppressed by the first arrangement groove 21a.
(3) The second fixed portion 22 is fastened and fixed to the exterior member 14 by the second fixing band B2 from the outer peripheral side, and the second arrangement groove 22a in which the second fixing band B2 is arranged is provided on the outer peripheral surface of the second fixed portion 22. With this configuration, movement of the second fixing band B2 can be restricted by the second arrangement groove 22a. Accordingly, displacement of the second fixing band B2 can be suppressed by the second arrangement groove 22a.

### Other Embodiments

The above embodiment can be modified as described below. The above embodiment and the following modifications can be combined with each other to the extent that no technical contradiction occurs.

The configuration of the folding portion 24 of the grommet 15, such as the shape, is not limited to that in the above embodiment and can be changed as appropriate depending on the configuration of the wire harness 10. For example, the angle of the mountain fold portions 31 and the valley fold portions 32 is not limited to 90° and may be an obtuse angle, for example.

In the above embodiment, the grommet 15 may be integrally provided with a holding portion that holds the folded state of the folding portion 24 by coupling the second fixed portion 22 and the housing portion 23 (or the folding portion 24), for example, when the folding portion 24 is in the folded state.

The material for forming the grommet 15 is not limited to that in the above embodiment, and may be changed as appropriate depending on the configuration of the wire harness 10.

The exterior member 14 may be a member other than a corrugated tube.

The embodiments disclosed herein are examples in all respects, and the present disclosure is not limited to these examples. That is, the scope of the present disclosure is defined by the claims, and it is intended to include all modifications within a meaning and scope equivalent to the scope of claims.

What is claimed is:

1. A grommet comprising:
a tubular body that includes:
a first fixed portion that is configured to be fixed to a tubular shield shell that covers an outer periphery of a connector housing;
a second fixed portion that is configured to be fixed to a tubular exterior member that covers an outer periphery of an electric wire extending from the connector housing; and
a tubular folding portion that is provided between the first fixed portion and the second fixed portion and has a diameter that decreases toward the second fixed portion, wherein:
the folding portion includes a plurality of annular mountain fold portions, a plurality of annular valley fold portions, and a plurality of coupling wall portions, each coupling wall portion of the plurality of coupling wall portions is between and couples a mountain fold portion of the plurality of mountain fold portions to a valley fold portion of the plurality of valley fold portions,
the plurality of mountain fold portions and the plurality of valley fold portions are alternately provided from a first fixed portion side toward a second fixed portion side, and
the folding portion is configured to be held in a folded state in which the plurality of coupling wall portions are aligned in a radial direction, by the plurality of mountain fold portions and the plurality of valley fold portions being folded.

2. The grommet according to claim 1, wherein:
the first fixed portion is configured to be fastened and fixed to the shield shell by a first fixing band from an outer peripheral side, and
a first arrangement groove in which the first fixing band is arrangeable is provided on an outer peripheral surface of the first fixed portion.

3. The grommet according to claim 1, wherein:
the second fixed portion is configured to be fastened and fixed to the exterior member by a second fixing band from an outer peripheral side, and
a second arrangement groove in which the second fixing band is arrangeable is provided on an outer peripheral surface of the second fixed portion.

4. A wire harness comprising the grommet according to claim 1.
